(19) United States
(12) Patent Application Publication
(10) Pub. No.: US 2010/0106594 A1
(43) Pub. Date: Apr. 29, 2010

(54) ADVERTISEMENT METHOD AND SYSTEM FOR DISPLAYING OPTIMUM TITLE AND DESCRIPTION BY ANALYZING CLICK STATISTICS

(75) Inventors: Ki Ho Song, Seoul (KR); Byounghak Kim, Seoul (KR); Minuk Kim, Seoul (KR)

Correspondence Address: H.C. PARK & ASSOCIATES, PLC, 8500 LEESBURG PIKE, SUITE 7500, VIENNA, VA, 22182, US

(73) Assignee: NHN BUSINESS PLATFORM CORPORATION, Seongnam-si (KR)

(21) Appl. No.: 12/530,260

(22) PCT Filed: Jan. 30, 2008
(86) PCT No.: PCT/KR08/00554

§ 371 Date: Sep. 8, 2009

(30) Foreign Application Priority Data
Mar. 8, 2007 (KR) 10-2007-0022755

(51) Int. Cl. G06Q 30/00; G06F 17/30

(52) U.S. Cl. 705/14.42; 707/769; 707/E17.108

(57) ABSTRACT

Provided is an advertising method and system for displaying optimal advertising content, the method including the steps of: maintaining an advertisement database that includes a plurality of advertising contents associated with a targeted site; randomly rolling and displaying the plurality of advertising contents associated with the targeted site by referring to the advertisement database, when displaying the targeted site as a search result; analyzing click statistics information associated with each of the randomly displayed advertising contents; and determining the optimal advertising content associated with the targeted site based on the analyzed click statistics information.

### CROSS-REFERENCE TO RELATED APPLICATIONS

This application is the National Stage of International Application No. PCT/KR2008/000554, filed Jan. 30, 2008, and claims priority from and the benefit of Korean Patent Application No. 10-2007-0022755, filed on Mar. 8, 2007, which are both hereby incorporated by reference for all purposes as if fully set forth herein.

### BACKGROUND OF THE INVENTION

1. Field of the Invention

The present invention relates to an advertising method and system that can randomly display a plurality of advertising contents associated with at least one of an advertisement campaign, an advertisement group, and a keyword of a targeted site, analyze click statistics information associated with each of the advertising contents, determine optimal advertising content, and then display the optimal advertising content with the targeted site.

2. Discussion of the Background

Generally, when a keyword is entered, a search system using the Internet can provide information associated with the keyword and can also provide associated advertisement data. Therefore, it is possible to improve the advertising effect. Due to the above advantages, an Internet advertisement is popular among advertisers as an optimal place to provide consumers with advertisement information.

An advertising method using advertising contents displays the advertising content, including a title and a description when Internet users enter a keyword.

One of conventional Internet advertisements stores in advance advertising content associated with a particular keyword and displays the advertising content corresponding to the particular keyword together with a search result when a user enters the particular keyword.

For example, an advertiser may register advertising content of the advertiser in an Internet search service providing system in association with a keyword “sneakers”. In this case, when a search service user accesses an Internet search server to enter the keyword “sneakers”, the advertising content may be displayed for the user in the form of a title and a description.

However, in this service type, the advertiser should change advertising content. In addition, the advertiser should directly determine the title and the description to be included in the advertising content. Therefore, it may be difficult to effectively advertise a product.

In another advertising method, an advertiser registers in advance an advertisement to be displayed at a particular point in time in an Internet search service providing system. In this case, when the particular point in time arrives, the advertising content may be displayed. However, this advertising method may randomly display a plurality of advertising contents in a limited advertisement region. Therefore, it is difficult to draw a user's attraction on a targeted side and thus may have reduced advertising effect.

In order to solve the above-described problems, there is a need for an advertising method that can determine optimal advertising content and display the optimal advertising content during a predetermined period of time. However, it may be difficult to identify a user preference needed to determine the optimal advertising content.

### SUMMARY OF THE INVENTION

An aspect of the present invention provides an advertising method and system that can randomly display a plurality of advertising contents associated with at least one of an advertisement campaign, an advertisement group, and a keyword of a targeted site, analyze click statistics information associated with each of the advertising content, determine optimal advertising content, and then display the optimal advertising content, in order to determine optimal advertising content for maximizing the advertising effect.

Another aspect of the present invention also provides an advertising method and system for displaying optimal advertising content based on analysis of click statistics that can match in an n:n ratio and store a plurality of advertisement campaigns, advertisement groups, and keywords with a plurality of advertising content, randomly roll and display the matched plurality of advertising contents, analyze click statistics information associated with each of the randomly displayed advertising contents, and determine an optimal combination, and thereby display advertising content according to the optimal combination.

According to an aspect of the present invention, there is provided an advertising method of displaying optimal advertising content based on analysis of click statistics, the method including the steps of: maintaining an advertisement database that includes a plurality of advertising contents associated with a targeted site; randomly rolling and displaying the plurality of advertising contents associated with the targeted site by referring to the advertisement database, when displaying the targeted site as a search result; analyzing click statistics information associated with each of the randomly displayed advertising contents; and determining the optimal advertising content associated with the targeted site based on the analyzed click statistics information.

In this instance, the step of maintaining may maintain the plurality of advertising contents in association with at least one of an advertisement campaign, an advertisement group, and a keyword.

Also, the step of rolling and displaying may randomly select, for the displaying, any one advertising content from the plurality of advertising contents. The click statistics information includes the optimal advertising content that includes click through rate (CTR) information.

Also, the step of determining may determine, as the optimal advertising content, advertising content corresponding to maximum CTR information among the CTR information associated with the plurality of advertising contents.

According to another aspect of the present invention, there is provided an advertising method of displaying optimal advertising content, the method including the steps of: matching a plurality of keywords with a plurality of advertising content to thereby maintain the matched plurality of keywords and the plurality of advertising contents in an advertisement database; randomly rolling and displaying the plurality of advertising content with respect to each of the keywords by referring to the advertisement database, when displaying a search result; analyzing click statistics information associated with each of the randomly displayed advertising contents with respect to each of the keywords; and determining an optimal combination between the plurality of keywords and the plurality of advertising contents, based on the analyzed click statistics information.

According to still another aspect of the present invention, there is provided an advertising method of displaying optimal advertising content, the method including the steps of: matching a plurality of advertisement campaigns/groups with a plurality of advertising content to thereby maintain the matched plurality of advertisement campaigns/groups and the plurality of advertising contents in an advertisement database; randomly rolling and displaying the plurality of advertising contents with respect to each of the advertisement campaigns/groups by referring to the advertisement database, when displaying a search result; analyzing click statistics information associated with each of the randomly displayed advertising contents with respect to each of the advertisement campaigns/groups; and determining an optimal combination between the plurality of advertisement campaigns/groups and the plurality of advertising contents, based on the analyzed click statistics information.

According to yet another aspect of the present invention, there is provided an advertising system for displaying optimal advertising content, the system including: an advertisement database configured to include and maintain a plurality of advertising contents associated with a targeted site; a display module configured to randomly roll and display the plurality of advertising contents associated with the targeted site by referring to the advertisement database, when displaying the targeted site as a search result; an analyzing module configured to analyze click statistics information associated with each of the randomly displayed advertising contents; and a determining module configured to determine the optimal advertising content associated with the targeted site based on the analyzed click statistics information.

According to another aspect of the present invention, there is provided an advertising system of displaying optimal advertising content, the system including: an advertisement database configured to match a plurality of advertisement campaigns/groups with a plurality of advertising content and thereby maintain the matched plurality of advertisement campaigns/groups and the plurality of advertising contents; a display module configured to randomly roll and display the plurality of advertising contents with respect to each of the advertisement campaigns/groups by referring to the advertisement database, when displaying a search result; an analyzing module configured to analyze click statistics information associated with each of the randomly displayed advertising contents with respect to each of the advertisement campaigns/groups; and a determining module configured to determine an optimal combination between the plurality of advertisement campaigns/groups and the plurality of advertising contents, based on the analyzed click statistics information.

### BRIEF DESCRIPTION OF THE DRAWINGS

FIG. 1 illustrates a configuration of an advertising system for displaying optimal advertising content based on click statistics information according to an embodiment of the present invention;

FIG. 2 is a flowchart illustrating an advertising method of displaying optimal advertising content based on click statistics information according to an embodiment of the present invention;

FIG. 3 illustrates a relation among an advertisement campaign, an advertisement group, and a keyword according to an embodiment of the present invention;

FIG. 4 illustrates the structure of an advertisement database that associates a keyword with advertising content according to an embodiment of the present invention;

FIG. 5 is a flowchart illustrating an advertising method of displaying optimal advertising content based on click statistics information according to another embodiment of the present invention;

FIG. 6 illustrates an example of matching a plurality of keywords with a plurality of advertising contents in an n:n ratio according to an embodiment of the present invention; and

FIG. 7 is a block diagram illustrating an advertising system for displaying optimal advertising content based on click statistics information according to an embodiment of the present invention.

### DETAILED DESCRIPTION OF THE ILLUSTRATED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

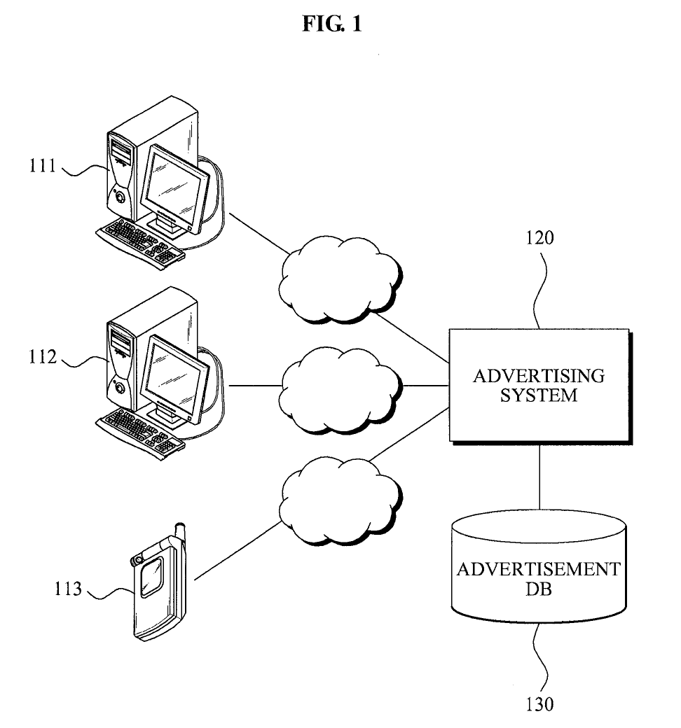

FIG. 1 illustrates a configuration of an advertising system 120 for displaying optimal advertising content based on click statistics information according to an embodiment of the present invention.

As shown in FIG. 1, the advertising system 120 for displaying the optimal advertising content may extract advertising content from an advertisement database 130 and randomly roll and display the extracted advertising content for users 111, 112, and 113. The advertisement database stores and maintains a plurality of advertising contents regarding a targeted site in association with at least one of an advertisement campaign, an advertisement group, and a keyword.

The advertising system 120 may determine optimal advertising content based on click statistics information associated with the randomly displayed advertising content according to a search request from the users 111 through 113. The advertising system 120 may display the targeted site and the determined optimal advertising content for a plurality of users including the users 111 through 113.

The advertising content is one of advertisement types and includes a title and a description regarding a click-before advertisement. As described above, according to the present invention, it is possible to determine optimal advertising content among a plurality of advertising contents associated with a keyword that is entered from a search request user, display the determined advertising content during a predetermined period of time, and thereby maximize the advertising effect associated with a targeted site.

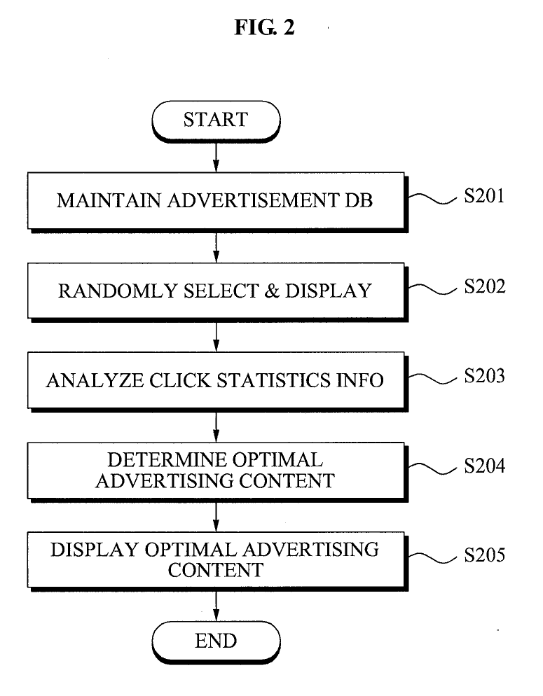

Hereinafter, an advertising method and system for displaying optimal advertising content will be described in detail with reference to FIGS. 2 through 7.

FIG. 2 is a flowchart illustrating an advertising method of displaying optimal advertising content based on click statistics information according to an embodiment of the present invention. As shown in FIG. 2, the advertising method of displaying the optimal advertising content may be performed through operations 5201 through 5205.

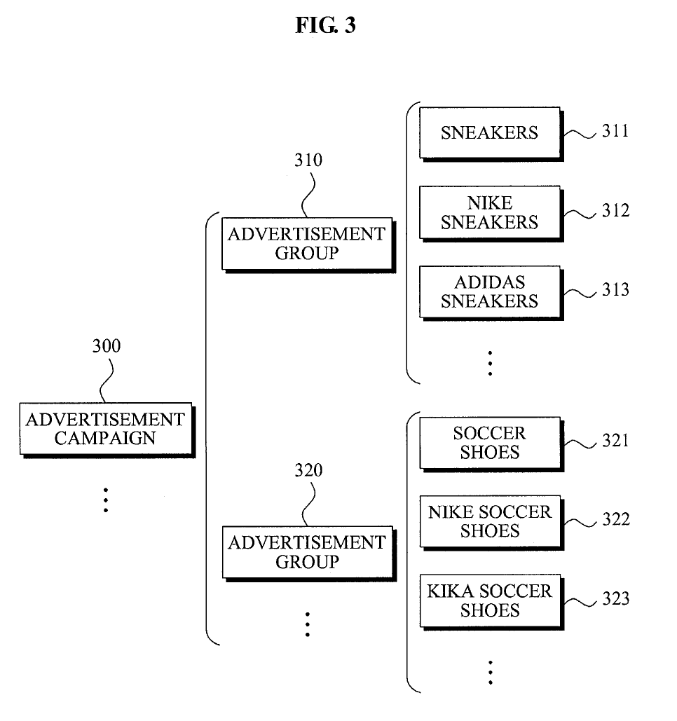

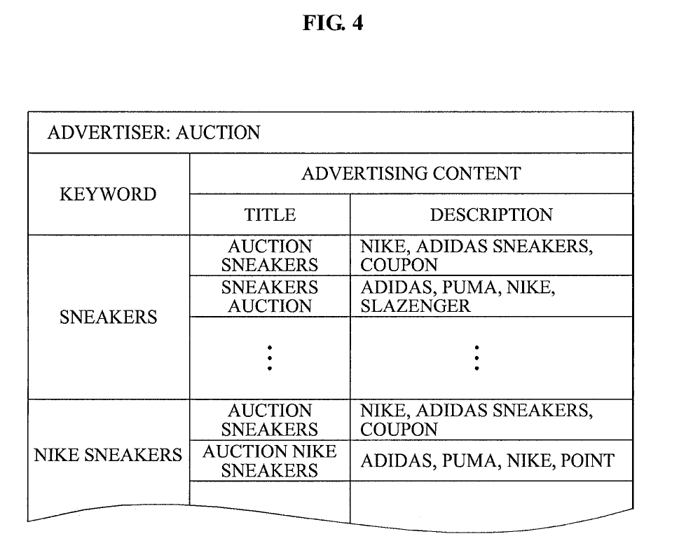

In operation 5201, an advertising system for displaying the optimal advertising content may maintain, in an advertisement database, a plurality of advertising contents associated with at least one of an advertisement campaign, an advertisement group, and a keyword of a targeted site. Operation 5201 will be further described in detail with reference to FIGS. 3 and 4.

In operation 5202, the advertising system may randomly select advertising content from the plurality of advertising contents by referring to the advertisement database and display the randomly selected advertising content.

More specifically, when an Internet user enters a keyword for a search request, the advertising system may display the advertising content as a result of the search request. The displayed advertising content may be randomly determined from the plurality of advertising contents. The plurality of advertising contents may be extracted from the advertisement database of operation S201. The advertisement database may maintain the plurality of advertising contents in association with any one of the advertisement campaign, the advertisement group, and the keyword. Therefore, the plurality of advertising contents may exist for each of the advertisement campaign, the advertisement group, and the keyword.

In operation S203, the advertising system may analyze click statistics information. The click statistics information includes click through rate (CTR) information about each of the displayed advertising contents.

As described above, CTR indicates click through rate and is a percentage that indicates how many times a corresponding advertisement was clicked on among a total number of times that the advertisement is displayed for visitors. For example, when 100 visitors visited a site that includes an online advertisement and in this instance, a single visitor clicked on the online advertisement and thereby is linked to a desired homepage of an advertiser, a corresponding CTR is 1%. The CTR is an important unit to measure the advertising effect associated with the online advertisement. When the online advertisement induces a visitor of a website to click on and thereby be linked to the advertiser's webpage, it can be said that the online advertisement succeeded in arousing the visitor's curiosity.

In operation S203, the advertising system may verify a number of times that the user views the advertising content displayed with the targeted site as the search result and then clicks on the advertising content and is linked to the targeted site, and may thereby calculate the CTR.

More specifically, when calculating the CTR, the advertising system may calculate the percentage based on a number of displays and a number of clicks on each of the plurality of advertising contents. For example, when a number of displays of particular advertising content is 100 and a number of clicks thereon is 15, the CTR of the particular advertising content is 15%. Also, when calculating the CTR, there may be a method that can calculate the average of CTRs and thereby determine the final CTR. It is also possible to use a method of determining a lowest limit, for example, 5% and extracting only a variable that indicates CTR greater than the lowest limit to obtain the average and determine the average as the final CTR.

In operation S203, when calculating the CTR, the advertising system may analyze click statistics information corresponding to a predetermined period of time, for example, a day, with respect to each of the randomly displayed advertising contents. The analysis is performed because the user's preferred advertising content may change for each predetermined period and thereby CTR may be changed. Specifically, this is in order to review general Internet users' preference for each predetermined period and effectively provide advertisements. The predetermined period may be determined based on a demand of the advertiser, keyword characteristics, and an analysis result of the user preference.

In operation S204, the advertising system may determine the optimal advertising content associated with the targeted site based on the analyzed click statistics information.

The click statistics information may be CTR information associated with each of the advertising contents. The advertising content corresponding to the maximum advertising content among the CTR information may be determined as the optimal advertising content. For example, when a plurality of titles “auction sneakers”, “sneakers auction”, and “find sneakers auction” is included in a plurality of advertising contents, each consisting of a title and a description, associated with a keyword “sneakers” and CTR of “auction sneakers” is 17%, CTR of “sneakers auction” is 15%”, and CTR of “find sneakers auction” is 10% in operation 203, the advertising system may determine, as optimal advertising content, advertising content having the higher CTR that includes the title “auction sneakers” with respect to the keyword “sneakers” in operation S204. Also, it is possible to analyze the CTR information based on the advertisement campaign and the advertisement group corresponding to an upper layer concept that includes the keyword “sneakers”.

In operation S205, the advertising system may display the determined optimal advertising content with the targeted site as the search result of the keyword. However, when the optimal advertising content determined through operations S201 through S204 is determined in association with the advertisement campaign and the advertisement group, instead of the keyword, the optimal advertising content may be displayed with the targeted site as the search result of all the keywords that belong to the advertisement campaign and the advertisement group.

FIG. 3 illustrates a relation among an advertisement campaign, an advertisement group, and a keyword according to an embodiment of the present invention.

According to an exemplary embodiment of the present invention, the advertisement group may be a keyword set that includes at least one keyword. The advertisement campaign may be an advertisement group set that includes at least one advertisement group constructed as above. For example, an advertisement group A that includes a keyword “TV/video/audio” and an advertisement group B that includes a keyword “washer/freezer/cleaner” may be included in an advertisement campaign.

Referring to FIG. 3, “sneakers” 311, “nike sneakers” 312, and “adidas sneakers” 313 are keywords. Soccer shoes 321, nike soccer shoes 322, and kika soccer shoes 323 are also keywords. The keywords 311 through 313 may be included in a single advertisement group 310 depending on meaning thereof, expression thereof, or a selection of an advertiser that purchases a keyword. The advertisement group 310 and another advertisement group 320 may be included in a single advertisement campaign 300. A standard to classify an advertisement campaign, an advertisement group, and a keyword may be determined by the advertiser and may also be determined by an advertising system for displaying optimal advertising content. Also, it is possible to generate a greater upper concept by grouping advertisement campaigns and to thereby display the optimal advertising content. In operations S201 through S205, the advertising system may determine and display the optimal advertising content in association with at least one of the advertisement campaign, the advertisement group, and the keyword.

FIG. 4 illustrates the structure of an advertisement database that associates a keyword with advertising content according to an embodiment of the present invention.

Referring to FIG. 4, in the advertisement database, the keyword is associated with the advertising content. Even an advertisement database that associates the advertising content with an advertisement campaign and an advertisement group may be maintained in the form as shown in FIG. 4.

Referring to FIG. 4, a plurality of advertising contents associated with a keyword “sneakers” includes “auction sneakers” as a title and “nike, adidas sneakers, coupon” as a description and also includes “sneakers auction” as the title and “adidas, puma, nike, slazenger” as the description. In operation S202 of FIG. 2, the advertising system may randomly roll and display the plurality of advertising contents associated with the targeted site by referring to the advertisement database that associates the keyword with the plurality of advertising contents. In operation S203, the advertising system may analyze CTR of each of the advertising contents. In operation S204, the advertising system may determine, as the optimal advertising content of the keyword, advertising content corresponding to the maximum CTR.

According to another exemplary embodiment of the present invention, the advertisement system may determine a plurality of advertising contents with respect to all the keywords that are included in the advertisement campaign and thereby determine and display optimal advertising content associated with the advertisement campaign in operations S201 through S205. The advertising system may determine the plurality of advertising contents with respect to all the keywords that are included in the advertisement group and thereby determine and display optimal advertising content associated with the advertisement group in operations S201 through S205.

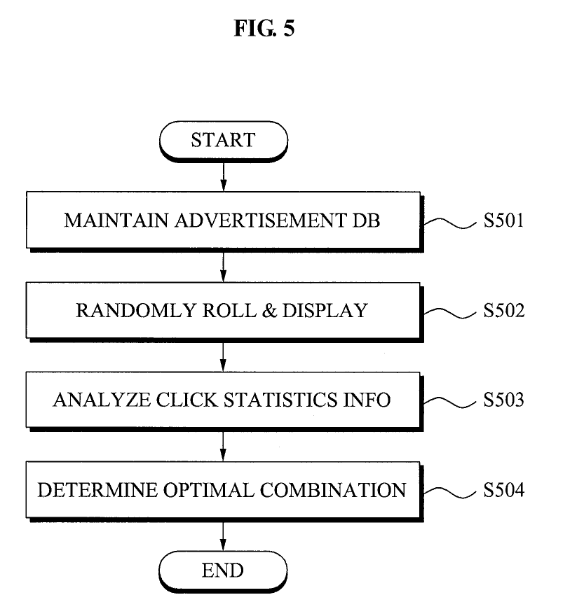

FIG. 5 is a flowchart illustrating an advertising method of displaying optimal advertising content based on click statistics information according to another embodiment of the present invention. As shown in FIG. 5, the advertising method of displaying the optimal advertising content may be performed through operations S501 through S504.

In operation S501, an advertising system for displaying the optimal advertising content may match a plurality of keywords with a plurality of advertising content in an n:n ratio to thereby maintain the matched plurality of keywords and the plurality of advertising contents in an advertisement database.

In operation S502, the advertising system may randomly roll and display the plurality of advertising content with respect to each of the keywords by referring to the advertisement database, when displaying a search result.

In operation S503, the advertising system may analyze click statistics information associated with each of the randomly displayed advertising contents with respect to each of the keywords. In operation S504, the advertising system may determine an optimal combination between the plurality of keywords and the plurality of advertising contents based on the analyzed click statistics information.

In operations S501 through S504, the advertising system may replace the keyword with any one of an advertisement campaign and an advertisement group to thereby determine the optimal combination between the advertisement campaign or advertisement group and the plurality of advertising content.

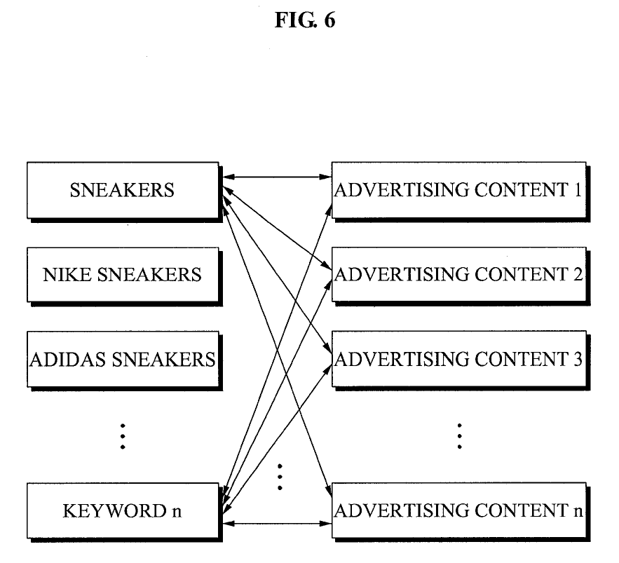

FIG. 6 illustrates an example of matching a plurality of keywords with a plurality of advertising contents in an n:n ratio according to an embodiment of the present invention.

The advertising system may match n keywords, including keywords “sneakers”, “nike sneakers”, and “adidas sneakers”, with n advertising contents in an n:n ratio to thereby maintain the matched n keywords and the n advertising contents in the advertisement database.

The advertising system may replace the keyword with any one of an advertisement campaign and an advertisement group to be matched with the n advertising contents in an n:n ratio and thereby maintain the matched advertisement campaign or the advertisement group and the advertising content in the advertisement database.

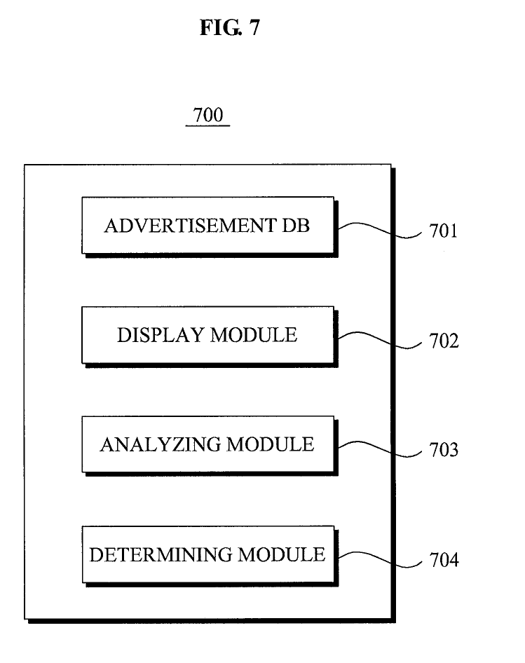

FIG. 7 is a block diagram illustrating an advertising system 700 for displaying optimal advertising content based on click statistics information according to an embodiment of the present invention. As shown in FIG. 7, the advertising system 700 according to an exemplary embodiment of the present invention may include an advertisement database 701, a display module 702, an analyzing module 703, and a determining module 704.

The advertisement database 701 may maintain a plurality of advertising contents in association with at least one of an advertisement campaign, an advertisement group, and a keyword.

The display module 702 may select advertising content from the plurality of advertising contents and display the selected advertising content. Also, after the determining module 704 determines the optimal advertising content, the display module 702 may display the optimal advertising content with the targeted site as the search result.

The analyzing module 703 may analyze click statistics information corresponding to a predetermined period of time with respect to each of the randomly displayed advertising content.

The determining module 704 may determine the optimal advertising content associated with the targeted site based on the analyzed click statistics information.

According to another exemplary embodiment of the present invention, the advertising system 700 may include the advertisement database 701, the display module 702, the analyzing module 703, and the determining module 704.

In this exemplary embodiment, the advertisement database 701 may match and maintain a plurality of advertisement campaigns/groups/keywords with a plurality of advertising contents in an n:n ratio to thereby maintain the matched plurality of advertisement campaigns/groups/keywords and the plurality of advertising contents.

The display module 702 may randomly roll and display the plurality of advertising contents with respect to each of the advertisement campaigns/groups/keywords by referring to the advertisement database, when displaying a search result.

The analyzing module 703 may analyze click statistics information associated with each of the randomly displayed advertising contents with respect to each of the advertisement campaigns/advertisement groups/keywords.

The determining module 704 may determine an optimal combination between the plurality of advertisement campaigns/groups/keywords, based on the analyzed click statistics information.

The exemplary embodiments of the present invention include computer-readable media including program instructions to implement various operations when executed by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

According to the exemplary embodiments of the present invention, an advertising method and system for displaying optimal advertising content based on analysis of click statistics may enable an advertiser to readily change advertising content consisting of a title and a description and may also maximize the advertising effect. The advertiser may assume a particular title and description is associated with a particular keyword. However, according to the present invention, it is possible to randomly roll and display advertising content associated with a corresponding advertisement and thereby retrieve optimal advertising content. Accordingly, the advertising method and system according to the present invention may achieve advertiser satisfaction and maximum advertising effect. Also, it is possible to improve the advertising quality in view of the user satisfaction.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An advertising method of displaying optimal advertising content, comprising:
maintaining an advertisement database that includes a plurality of advertising contents associated with a targeted site;
rolling and displaying the plurality of advertising contents associated with the targeted site by referring to the advertisement database, when displaying the targeted site as a search result;
analyzing click statistics information associated with each of the displayed advertising contents; and
determining the optimal advertising content associated with the targeted site based on the analyzed click statistics information.

2. The method of claim 1, wherein the plurality of advertising contents are associated in the advertising database with at least one of an advertisement campaign, an advertisement group, and a keyword.

3. The method of claim 1, wherein the step of rolling and displaying comprises selecting, for the displaying, any one advertising content from the plurality of advertising contents.

4. The method of claim 1, wherein the click statistics information comprises click through rate (CTR) information.

5. The method of claim 4, wherein the optimal advertising content is determined as advertising content corresponding to maximum CTR information among the CTR information associated with the plurality of advertising contents.

6. The method of claim 1, wherein the step of analyzing comprises analyzing the click statistics information corresponding to a predetermined period of time with respect to each of the displayed advertising content.

7. The method of claim 6, further comprising:
displaying the optimal advertising content with the targeted site as the search result, when the optimal advertising content is determined.

8. An advertising method of displaying optimal advertising content, comprising:
matching a plurality of keywords with a plurality of advertising content to thereby maintain the matched plurality of keywords and the plurality of advertising contents in an advertisement database;
rolling and displaying the plurality of advertising content with respect to each of the keywords by referring to the advertisement database, when displaying a search result;
analyzing click statistics information associated with each of the displayed advertising contents with respect to each of the keywords; and
determining an optimal combination between the plurality of keywords and the plurality of advertising contents, based on the analyzed click statistics information.

9. An advertising method of displaying optimal advertising content, comprising:
matching a plurality of advertisement campaigns/groups with a plurality of advertising content to thereby maintain the matched plurality of advertisement campaigns/groups and the plurality of advertising contents in an advertisement database;
rolling and displaying the plurality of advertising contents with respect to each of the advertisement campaigns/groups by referring to the advertisement database, when displaying a search result;
analyzing click statistics information associated with each of the displayed advertising contents with respect to each of the advertisement campaigns/groups; and
determining an optimal combination between the plurality of advertisement campaigns/groups and the plurality of advertising contents, based on the analyzed click statistics information.

10. A computer comprising a processor and a computer-readable recording medium storing a program for implementing the method according to claim 1 when executed.

11. An advertising system for displaying optimal advertising content, comprising:
an advertisement database configured to include and maintain a plurality of advertising contents associated with a targeted site;
a display module configured to roll and display the plurality of advertising contents associated with the targeted site by referring to the advertisement database, when displaying the targeted site as a search result;
an analyzing module configured to analyze click statistics information associated with each of the displayed advertising contents; and
a determining module configured to determine the optimal advertising content associated with the targeted site based on the analyzed click statistics information.

12. The system of claim 11, wherein the advertisement database maintains the plurality of advertising contents in association with at least one of an advertisement campaign, an advertisement group, and a keyword.

13. The system of claim 11, wherein the display module selects, for the displaying, any one advertising content from the plurality of advertising contents.

14. The system of claim 11, wherein the analyzing module analyzes the click statistics information corresponding to a predetermined period of time with respect to each of the displayed advertising contents.

15. The system of claim 14, wherein the display module displays the optimal advertising content with the targeted site as the search result, when the optimal advertising content is determined.

16. An advertising system of displaying optimal advertising content, comprising:
an advertisement database configured to match a plurality of keywords with a plurality of advertising content in an n:n ratio and thereby maintain the matched plurality of keywords and the plurality of advertising content;
a display module configured to roll and display the plurality of advertising content with respect to each of the keywords by referring to the advertisement database, when displaying a search result;
an analyzing module configured to analyze click statistics information associated with each of the displayed advertising contents with respect to each of the keywords; and
a determining module configured to determine an optimal combination between the plurality of keywords and the plurality of advertising contents, based on the analyzed click statistics information.

17. An advertising system of displaying optimal advertising content, comprising:
an advertisement database configured to match a plurality of advertisement campaigns/groups with a plurality of advertising content and thereby maintain the matched plurality of advertisement campaigns/groups and the plurality of advertising contents;
a display module configured to roll and display the plurality of advertising contents with respect to each of the advertisement campaigns/groups by referring to the advertisement database, when displaying a search result;
an analyzing module configured to analyze click statistics information associated with each of the displayed advertising contents with respect to each of the advertisement campaigns/groups; and
a determining module configured to determine an optimal combination between the plurality of advertisement campaigns/groups and the plurality of advertising contents, based on the analyzed click statistics information.

18. A computer comprising a processor and a computer-readable recording medium storing a program for implementing the method according to claim 8 when executed.

19. A computer comprising a processor and a computer-readable recording medium storing a program for implementing the method according to claim 9 when executed.

20. The system of claim 11, wherein the optimal advertising content is determined as advertising content corresponding to a maximum click through rate (CTR) information among CTR information associated with the plurality of advertising contents.
